(19) United States
(12) Patent Application Publication
(10) Pub. No.: US 2004/0046927 A1
(43) Pub. Date: Mar. 11, 2004

(54) Polarized and non-polarized bifocal spectacles

(76) Inventor: Mark E. Montgomery, Beverly Hills, CA (US)

Correspondence Address: Michael McEntee, Attorney at Law, Suite 100, 15802 Chemical Lane, Huntington Beach, CA, 92649, US

(21) Appl. No.: 10/649,416

(22) Filed: Aug. 27, 2003

Related U.S. Application Data
(60) Provisional application No. 60/406,519, filed on Aug. 27, 2002.

(51) Int. Cl. G02C 7/16

(52) U.S. Cl. 351/46

(57) ABSTRACT

The present invention teaches a new category of bifocal sunglasses utilizing a vertically polarized upper lens portion and a non-polarized light absorbing lower lens segment mechanically affixed to the upper portion.

### CROSS REFERENCE AND REQUEST FOR PRIORITY

Applicant filed a Provisional Patent Application on Aug. 27, 2002, on the subject described herein. Applicant's PTO serial number is No. 60/406,519.

### FEDERALLY SPONSORED RESEARCH

None

### SEQUENCE LISTING ON PROGRAM

None

### BACKGROUND OF THE INVENTION

1. Field of the Invention

The present invention teaches a new category of bifocal sunglasses utilizing a dichroic vertically polarized upper lens portion and a non-polarized light absorbing lower lens segment mechanically affixed to the upper portion. The field of invention includes both prescription bifocals having optical magnification and non-prescription bifocals having little or no magnifying power. The specific problem solved by the invention is that at certain angles of rotation, polarized sunglasses filter out the polarized light which emits from liquid crystal displays, making it impossible to read the display.

2. Description of the Prior Art

Boaters, heavy equipment operators, and pilots of airplanes, among others must read electronic instruments which utilize liquid crystal displays. One of the main advantages of liquid crystal displays is that they can be seen quite well in bright sunlight. By contrast, cathode ray tubes, light emitting diode displays, and florescent screens are often impossible to read in bright sunlight.

At the same time, boaters, heavy equipment operators, and pilots of airplanes typically wear sunglasses to shield their eyes from intense sunlight. Whether the sunlight is direct from the sun, or reflected off reflective surfaces, the intense light needs to be filtered to protect one's eyes and to be able to see images which would be hidden by the glare.

There are two main types of sunglasses, the first is merely an absorber and reflector of a fraction of all wavelengths of sunlight. The other type of sunglasses selectively absorbs to destruction most horizontally polarized light rays and passes through most of the vertically polarized light. This results in elimination of most glare, while allowing a high degree of vision.

To understand the various equivalent designs engendered in the present invention, it is necessary to briefly describe the topics of liquid crystal displays, polarization, and bifocal spectacles in the context of the prior art.

(a.) Liquid Crystal Displays

Liquid crystal materials were described around 1889 by H. Reinitzer in Austria. It is only in the last 30 years that important practical applications have been found for these materials in the form of practical liquid crystal displays such as those used in a Global Position System unit. These displays normally take the form of flat panels of glass which are actually two sheets of glass hermetically sealed together with a sandwich of liquid crystal material between them.

The display, such as digits showing longitude and latitude in a GPS device, is formed between the two sheets of glass and in one form of display, can be viewed by transmitted light, while in another form, it is viewed by reflected light.

Liquid crystals are organic compounds rather similar to oils and with long rodlike molecules. In bulk these materials have a cloudy appearance, resembling milk, but when seen as a thin layer sandwiched between two sheets of glass, they are clear and practically transparent.

There are three main types of liquid crystal material. In all three types, the molecules are an elongated form best visualized as slippery transparent ‘sausages’. These ‘sausages’ are microscopic in size and it is only the combined effect of thousands of closely packing molecules which produces the observed effect of displaying numbers and other images.

In the first type of crystals, known as smetic, the molecules are highly ordered in the thin layer between the glass. They form themselves into discrete parallel layers; all the molecules in one layer are parallel to one another, and the molecules in different layers all point the same way.

In the second type, nematic, the molecules arrange themselves with their long axes parallel to one another but are not neatly arranged with respect to adjacent molecules, so that they exhibit a ‘grainy’ appearance.

In the third type, cholesteric, the molecules all point the same way in each layer but each layer is slightly twisted with respect to the ones above and below it so that over a large distance a continuous twist is observed to be superimposed upon the parallel arrangement.

All these types of materials flow like a liquid but exhibit physical properties similar to solid crystals over their working temperature range. Modernly, this temperature range is from minus 5 degrees Centigrade up to 65 degrees Centigrade. At the upper temperature, the liquid loses its special crystal properties and behaves like an ordinary liquid.

When the crystal material is in its working temperature range it is said to be in the mesophase or anisotropic state. In this condition it has properties similar to those of crystals, in that the light passing through the material from different angles suffers different degrees of refraction. Refraction is the bending of light rays. Conventional liquids on the other hand are said to be isotropic and thus exhibit no such special optical properties.

In operation of the liquid crystal display, an important feature of the ‘sausage’ like molecules of liquid crystal materials is that they possess electrical dipole axes, which are at 90 degrees to the long axes of the ‘sausage’ like molecules.

In the nematic type display, at rest, it is usually arranged by pretreatment of the glass so that the long axes of the ‘sausage’ like molecules are ‘standing up’ on the glass surfaces. Another term often used in optical physics and plane geometry for the orientation of the molecules is that they arranged “normal” to the glass plane. This means standing at right angles to the layer on which it is standing. For example, a vertical flag pole is “normal” to the surface of the earth.

When the operating voltage is applied, it has the effect of turning the molecules through a right angle so that the dipole axes are brought into line with the electrical field.

If this were all that happened the liquid in the display would still appear as a clear liquid, because all the molecules would still be lying parallel to one another.

In practice, however, free negative and positive ions in the liquid are drawn to the oppositely charged conducting surfaces and while passing through the liquid, the ions locally neutralize the field across the liquid in the sandwich. Ions are molecules which, by gaining or losing an electron, have obtained an electrical charge. When an electric field is applied, the negative ions head for the positive electrode, and the positive ions head for the negative electrode. The ions interact with the dipoles of the ‘sausage’ like molecules, resulting in small groups of molecules becoming randomly disoriented. It is these randomly arranged groups of molecules which, because of their anisotropic property, scatter light at their interfaces. The scattering arises from the groups each having differing refractive indices, to produce what visually appears to be a ‘milky’ or ‘ground glass’ effect. This effect produced in a display using nematic liquid is described as a dynamic scattering type of display.

One important result of this arrangement of glass layers and molecules is that the output signal displayed visually is in the form of polarized light, which gives rise to the problem solved by this invention.

An application of nematic liquid crystals is a four digit liquid crystal clock that might be mounted on the fly bridge of a yacht, a series of seven-bar digits might be formed between the two glass plates. Suppose each of the digits are to be three inches high by one inch wide (7.5×2.5 cm.) The thickness of the liquid in the sandwich would be about one thousandth of an inch (0.0025 cm) while the glass plates would be about one eighth of an inch thick (0.3 cm) to ensure sufficient rigidity in the glass to maintain the correct gap in the sandwich.

The inside surfaces of the glass plates have deposited on them the pattern which it is desired to be able to display in the form of a transparent conducting layer. This layer is typically tin oxide which has been sintered or baked into the glass.

Individual connections are made to these conducting areas by, for example, arranging for a row of contact areas along one edge of one of the glass plates so that it can be inserted into a matching contact socket.

The line of conducting material joining the contact area at the edge of the display to the shape to be displayed has to be laid out on one glass plate so that it is not facing any conducting area on the other plate. Only sections to be displayed have matching areas facing one another on opposite glass plates. An electrical circuit then selectively applies voltage to the conductive layers, and that produces the dipole rotation. As described above, the selective scattering of light, and refraction of ambient light, results in the numerical display of the digits.

Another form of liquid crystal display uses cholesteric liquid. It is operated on a different principle to that described above for nematic liquids. Cholesteric liquid displays make use of the fact that the regular twist in the molecule layers causes light passing through the liquid to be twisted. With no applied voltage, polarizing filters are placed on either side outside the glass sandwich of the display. The polarized filters are oriented so that some light passes through the sandwich. A small electrical voltage is then applied across the parts of the display to be shown. The electrical voltage is of sufficient amplitude to twist the molecules through 90 degrees. The light entering through one polarizing filter will not now be able to pass out through the polarizing filter on the other side. Hence, they will look black to the viewer. Alternatively, if the polarizing filters are initially arranged to stop all light, a 90 degree twist will produce a clear display.

One reason the liquid crystal display does not dazzle the eyes of the observer is that the visible output of the liquid crystal display is polarized. Whether semetic, nemetic, or cholesteric liquid displays are utilized, the result is a polarized set of rays. In effect, a liquid crystal display has its own set of polarized sunglasses.

Liquid crystal displays are found in many digital readout devices. They consume only about one thousandth of the power of other common forms of display, such as gas discharge or LED (Light emitting diode) semiconductors. They are the only form of electronic display which can be easily read in high ambient light levels, even direct sunlight, and in consequence are particularly suited to use in aircraft cockpit, boating, and car instrumentation, where the displays must be easily visible yet not dazzle the observer with glare. These advantages assure that liquid crystal displays will be the dominant mode of display for such electronic devices for a long time into the future. And, as a practical business matter, there is no way around the problem of having to deal with the polarized output of light.

This brings us to the next topic of the prior art, polarized sunglasses worn by the observer.

(b.) Polarizing Sunglasses

By far, the most commonly used polarizing sunglasses today utilize dichroic materials. I define dichroic to mean any substance which transmits only selected polarized rays of light, while substantially absorbing to extinction the rest of the light rays which try to pass through the dichroic material. Thus, a spray on coating which is converted to a polarizing material would be included in my definition of dichroic.

To understand this statement in the context of the prior art and the invention, it is helpful to briefly discuss polarization and polarizing filters used in sunglasses.

A light ray is created by the movement of charged particles, usually electrons spinning around an atom. The movement results in the release of energy in the form of a wave. Each light ray is understood to be a combination of electric and magnetic waves, with the magnetic field always at right angles to the electric field. It is usual to call the direction of polarization of the waves to be the same as that of the electric field.

It has become common to refer to ordinary light as unpolarized light, even though each individual wave has a definite polarization, and is itself, polarized.

For example, ordinary light, from sunlight or a light bulb, is produced by the movement of the electrons in a hot body. The important point for this patent is that because the motions are random, there are many separate waves of light. This means, on average, in ordinary light, there are polarized light rays for every one of the 360 degrees of orientation. For simplicity, I group these rays into two groups: “vertically polarized,” and the other, “horizontally polarized.” In ordinary light, there is about as many vertically polarized light rays as there are horizontally polarized light rays.

As stated above, the most commonly used polarizers today are made of dichroic materials. Those materials transmit most of the light in one polarization, and absorb to extinction most of the other waves.

A common analogy to a vertical polarizer is a set of closely spaced vertical wires acting as a screen. Only waves moving up and down would get through the screen. Waves of light moving side to side in a horizontal plane would be extinguished.

The analogy is useful because dichroic polarizers utilize millions of closely spaced stretched out organic molecules to act as the vertical “wires” in the screen.

For example, a sheet of polyvinyl alcohol is softened by heating and then rapidly stretched, in one direction only, to several times its original length. Polyvinyl alcohol has many long molecules which are initially jumbled together. By pulling in one direction, the molecules are stretched into parallel lines with each other. It is then fixed to a rigid backing, such as clear plastic, and then dipped into a solution containing iodine. The iodine reacts with the molecules of polyvinyl alcohol. The long parallel strings of iodine atoms form the fine conducting grid needed to screen out all light waves whose polarization does not match the fine lines.

Thus, the dichroic material filters out the non-conforming waves and allows the conforming waves to pass through.

Various grades of polarizing material are made which screen out different amounts of unwanted polarized waves. These have been developed since the invention of dichroic polarization filters in 1928. Today, many grades of “Polaroid” sunglasses are available. They are made with dichroic sheets. For use in making sunglasses, the dichroic material is formed into a shape to fit into the spectacle frames. Invariably, the polarization of the sunglasses is selected to permit vertical polarized waves of light to pass through, while absorbing to extinction the horizontal waves of light.

For example, sunlight reflected off horizontal surfaces, such as water, is partly horizontally polarized by its interaction with the surface of the water. This means that the reflection from the water is mostly light waves vibrating in the horizontal mode. Glare is simply this horizontally vibrating light waves.

If a boater is wearing vertically polarized sunglasses, the glare is almost entirely absorbed to extinction by the sunglasses. The result is much relief to the eyes of the boater due to the elimination of the glare, yet the boater can see plainly through the sunglasses.

But there is a drawback. If the polarization of the boater's glasses is in alignment with the polarization of the light rays emitted from the liquid crystal display, then the boater will see the display image. But, if they are not in alignment, then the display will appear dark and blank.

Consider a boater standing at the helm of the sailboat while underway, and the sailboat is tilted 30 degrees (which is not unusual on a sailboat), and the boater is compensating by leaning 30 degrees. The effect is to tilt the sun glasses 30 degrees relative to the horizon. The sunglasses are no longer “vertically polarized.”

Suppose the boater tries to look at a GPS, mounted at an angle near the helm. The GPS outputs its information on a liquid crystal display. As the boater looks down to read the display, while wearing polarized sunglasses, there are times when the difference in polarization between that of the liquid crystal display and the sunglasses is nearly 90 degrees. And the result is, the GPS display is filtered nearly to extinction by the sunglasses.

(c.) Bifocal Spectacles

The present invention teaches a new category of bifocal sunglasses utilizing a dichroic vertically polarized upper lens portion and a non-polarized light absorbing lower lens segment mechanically affixed to the upper portion.

It is known to place a vertically polarized Polaroid filter between a sandwich of crown or flint glass, and to form a lens. Two such lens mounted in eye glass frames then serve as polarizing sunglasses.

It is also known to use plastics, rather than glass, for ophthalmic lenses. The long-chain polymers and cross-linked resins are molded in glass molds. Both thermosetting and thermoplastic materials can be utilized to form the lenses.

In general, sunglasses can be made using plastic lenses, flint glass lenses, crown glass lenses, or other glass materials.

A search of the spectacle art does not reveal any reference to bifocal sunglasses utilizing a dichroic vertically polarized upper lens portion and a non-polarized light absorbing lower lens segment affixed to the upper portion. Accordingly, it is submitted that the applicant has discovered a new category of sunglasses.

### SUMMARY OF THE INVENTION

Surprisingly, despite millions of GPS units and other display devices being used daily, the problem of polarized sunglasses filtering out the signal from the displays has not been mentioned. Likewise, no solution has been mentioned. But once the problem is pointed out, then immediately the user recognizes the problem and the value of the solution. This is a classic indicator of nonobviousness.

This invention includes a pair of glasses adapted to enable a person to have his or her eyes shielded from the glare of the sun and also to be able to glance at a liquid crystal electronic display or other polarized display and to view that display at any angle of rotation of the display. Broadly, the invention includes a combination of: (1.) a frame for holding lenses to form spectacles, (2.) two or more transparent surfaces mounted in the frame, (3.) one or more polarizing filters covering the upper portions of the transparent surfaces, such that the pair of glasses function as bifocal glasses enabling the wearer to select between polarized and unpolarized light reception by merely moving the direction of the wearer's eyeballs.

### BRIEF DESCRIPTION OF THE DRAWINGS

FIG. 1 is a elevation view of a typical prescription bifocal pair of spectacles except that a polarizing filter has been inserted in the upper split lens as shown in FIG. 2.

FIG. 2 is a side cross section taken through FIG. 1, showing the polarizing filter mounted between the upper glass lens segments.

FIG. 3 shows a dis-assembled kryptok bifocal showing the polarizing filter segment 33.

FIG. 4 is a representative cross section of the assembled and cemented kryptok bifocal of FIG. 4.

FIG. 5 is a perspective view of a pair of sunglasses.

FIG. 6 is a cross section of FIG. 5 showing the lens.

FIG. 7 shows an alternate construction of the lens cross section from FIG. 5

### DETAILED DESCRIPTION OF THE PREFERRED EMBODIMENTS

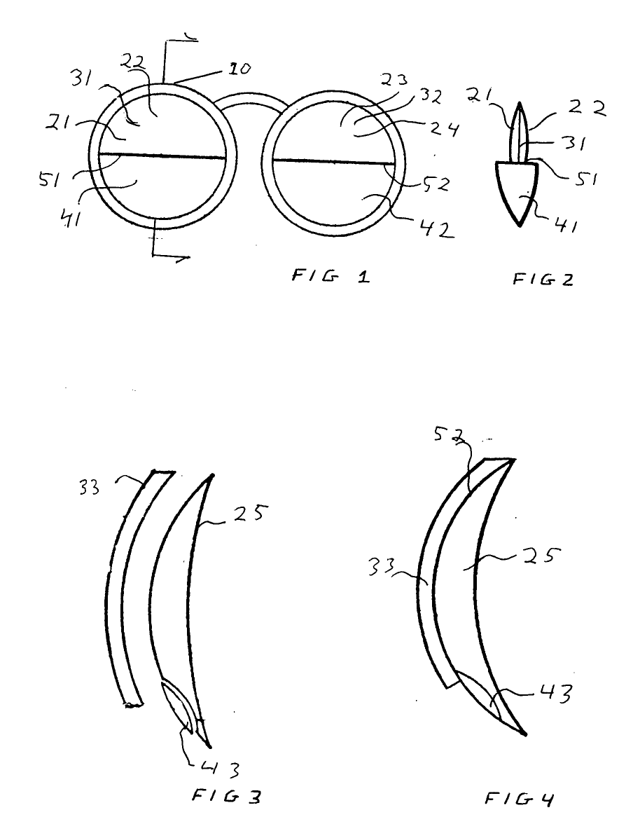

FIG. 1 shows an elevation view of a typical prescription bifocal pair of spectacles except that a polarizing filters 31 and 32 have been added. Spectacle frame 10 has mounted within it sets of lenses. Lens segment 21 and 22 are cemented together with polarizing filter 31, as shown in FIG. 2. Lower lens segments 41 and 42 are glass or plastic and do not have polarizing filter capability. FIG. 1 and FIG. 2 are intended to be representative of the whole set of equivalent combinations of sunglasses utilizing a dichroic vertically polarized upper lens portion and a non-polarized light absorbing lower lens segment 41 and 42, mechanically affixed to the upper portion. In this case, the mechanical method of affixing it to mount it in the spectacle frame 10. Equivalent methods of mounting are to cement the lens segments together at bifocal lines 51 and 52 as well as securing the lens segments in the frame 10.

If the bifocal lens were made of plastic, then the frame 10 would be either metal or plastic, the dichroic vertically polarized upper lens comprising lens segments 21 and 22 and filter material 31 could be one molded piece of polarizing filter material, cut and shaped to the optical curvature required by the prescription for the bifocal. Likewise, the lower non-polarizing lens segment could be made of non-polarizing plastic and can be shaped to have the optical curvature required by the prescription.

If there is no optical magnifying power designed into the lens segments, then the curvature of lens segments 21, 22, 23, 24, 41, and 42 will be much flatter than that shown.

Likewise, some commercial applications may be filled by having lens segments 21, 22, 23, 24 beings very thin and flat, while lower lens segments 41 and 42 would have some optical curvature so that the non-polarizing portion of the spectacles could be used to magnify the image being viewed.

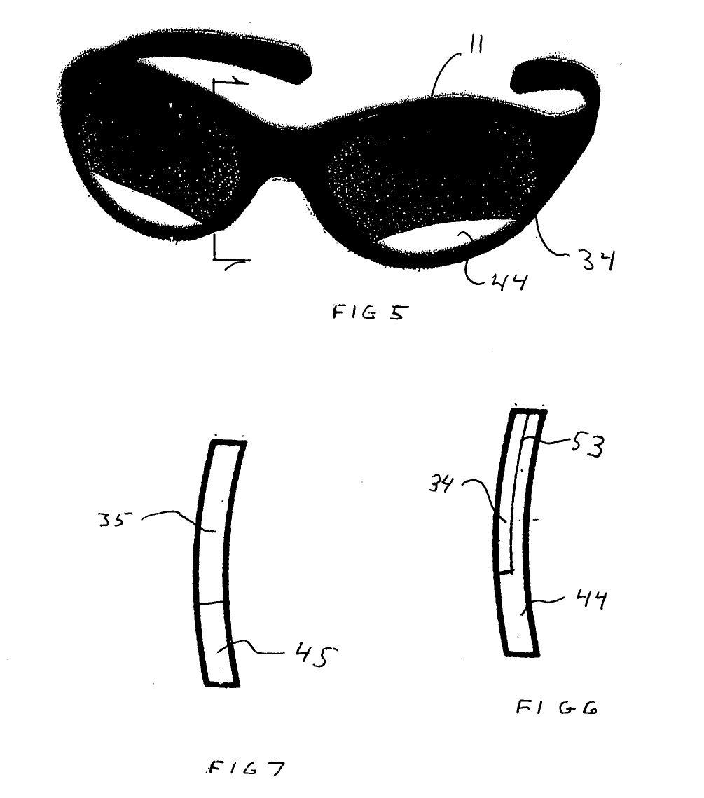

FIG. 3 shows a dis-assembled kryptok bifocal showing the polarizing filter segment 33. FIG. 4 is a representative cross section of the assembled and cemented kryptok bifocal of FIG. 4. Polarizing plastic filter 33 is cemented along glue line 52 to clear optical glass segment 25. Lower clear lens segment 43 might be added to provide additional magnification and to deal with image jump, object displacement, and vertical imbalance problems which arise in eye glass construction. The ordinary worker in the art is familiar with the precise adjustments in lens grinding and placement to deal with these issues. FIGS. 3 and 4 are to be understood as representative of the whole variety of bifocal constructions and are not limited to kryptok. Equivalent bifocal constructions include, without limitation, all combinations of lenses, whether cemented, mechanically held, fused, or held by screws. The invention is not limited to prescription bifocal sunglasses. Indeed the preferred embodiment includes both prescription bifocals having optical magnification and non-prescription bifocals having little or no magnifying power.

FIG. 5 is a perspective view of a pair of sunglasses showing the frame 11, polarizing material 34, and clear plastic or glass material 44.

FIG. 6 is a cross section of FIG. 5 showing the lens comprising polarizing material 34, clear plastic or glass material 44, and cement bonding 53.

FIG. 7 shows an alternate construction of the lens cross section from FIG. 5, wherein the lens is constructed of polarizing material 35 and non-polarizing material 45. The non-polarizing material can have light absorbing pigments within it to reduce visible light transmission.

In addition to the polarized light filtering feature of the preferred embodiments, each lens, whether clear or darkened or polarizing can have ultra violet absorbing material dispersed within it, or mounted on top of it.

While the embodiment of the invention shown and described is fully capable of achieving the results desired, it is to be understood that this embodiment has been shown and described for purposes of illustration only and not for purposes of limitation.

1 A pair of glasses adapted to enable a person to have his or her eyes shielded from the glare of the sun and also to be able to glance at a liquid crystal electronic display or other polarized display and to view that display at any angle of rotation of the display, comprising in combination:
a. a frame for spectacles,
b. two or more transparent surfaces mounted in the frame,
c. one or more polarizing filters covering portions of the transparent surfaces, such that the pair of glasses function as bifocal glasses enabling the wearer to select between polarized and unpolarized light reception by merely moving the direction of the wearer's eyeballs.
